(19) United States
(12) Patent Application Publication
(10) Pub. No.: US 2010/0012736 A1
(43) Pub. Date: Jan. 21, 2010

(54) BAR CODE AUTHENTICATION

(75) Inventors: Mark Wilds, Glasgow (GB); Steve Chambers, Glasgow (GB)

Correspondence Address: MOORE & VAN ALLEN PLLC, P.O. BOX 13706, Research Triangle Park, NC, 27709, US

(73) Assignee: ITI Scotland Limited, Glasgow (GB)

(21) Appl. No.: 12/306,460

(22) PCT Filed: Jul. 4, 2007
(86) PCT No.: PCT/GB07/02496

§ 371 Date: Jul. 8, 2009

(30) Foreign Application Priority Data
Jul. 5, 2006 (GB) 0613360.7

(51) Int. Cl. G06K 19/06

(52) U.S. Cl. 235/494

(57) ABSTRACT

A method for embedding secondary information in a bar code that includes primary information, the method comprising varying the periphery of selected ones of the bars or pixels of the code and/or varying the periphery of at least some of the bars or pixels by different amounts and/or varying the peripheral shape of at least some of the bars or pixels.

The present invention relates to improvements in bar code authentication/security. In particular, the present invention relates to the addition of secondary features that can be used to authenticate a bar code in anti-counterfeiting measures.

### BACKGROUND OF THE INVENTION

Machine readable taggants are commonly used by brand owners in product tracking systems. Known taggants include barcodes, radio frequency identification (RFID) tags and the like. Products to be tracked are each fitted with a tag that has unique identification information that can be retrieved by scanning or otherwise reading the tag at a later time. Whilst these tracking arrangements are useful, many remain susceptible to counterfeiting. Some attempts have been made to overcome this problem. Unfortunately, however, many known anti-counterfeiting solutions require the inclusion of new materials and additional reader technology. This is proving to be a significant barrier to widespread adoption of the technology.

WO2004/097714 describes barcodes that include embedded security features. The system described in WO2004/097714 goes some way to addressing some of the problems with other, known anti-counterfeiting systems.

CN1558595A describes a method for generating and verifying linear bar codes that uses a digital signature and digital watermark. In this, the width of every bar of the code is modulated by the same amount. This width modulation is then used as a means to authenticate the bar code. Whilst these techniques can be useful, there remains a need for simple mechanisms for improving bar code integrity.

### SUMMARY OF THE INVENTION

According to one aspect of the present invention, there is provided a method comprising embedding secondary information in a bar code that includes primary information by varying the periphery of selected ones of the bars or pixels of the code and/or by varying the periphery of at least some of the bars or pixels by different amounts and/or by varying the peripheral shape of the bars or pixels.

Preferably, any changes to the periphery are indiscernible by eye, so that the, or each bar appears to be of a conventional shape. The varying of the periphery of at least one bar may include distorting at or around the periphery of the at least one bar.

For 1D linear bar codes, preferably, the bars that include secondary information have a width that varies from the unit width X of the bar without the secondary information by less than X/10.

Embedding secondary information in the periphery of the bars may be done using a distortion function. The distortion function may be applied over the whole of the bar code. Alternatively, the function may be applied over part of the code.

The shape of the bars may be varied from that of conventional codes. For example, bars that include secondary information may have a trapezoidal shape or at least one curved side. Alternatively or additionally, at least one corner of at least one bar or pixel may be rounded off to encode the secondary information.

Additionally or alternatively, the height and/or width of the bars may be varied, thereby to embed secondary information. For linear bar codes, the bar height may be varied by an amount that is less than or equal to 5% of the original height or X/3, wherein X is the bar width.

The bar code may be a linear bar code or a stacked bar code or a two dimensional bar code.

Where the bar code is 2D, like pixels that form a boundary with pixels of a different colour may be grouped together as a block and the periphery of the pixels in the block varied by the same amount, thereby to embed secondary information. For example a group of black pixels that extend partially across a row may be varied by the same amount. By varying all of the pixels in a block by the same amount variations in pixel size are less obvious.

Bars in different blocks may be varied by the same or different amounts. At least one block may extend horizontally. At least one block may extend vertically.

According to another aspect of the invention, there is provided a printed bar code comprising one or more bars in which secondary information is embedded at the periphery of selected ones, but not all, of the bars.

A printed bar code comprising a plurality of bars at least some of which are modulated at their peripheries by different amounts or in different ways.

According to another aspect of the invention, there is provided a printed bar code comprising one or more bars distorted peripherally relative to at least one other bar to embed secondary information. Preferably, the secondary information can be used to authenticate the bar code.

Preferably, the peripheral shape of the bars includes the secondary information. One or more of the bars may be trapezoidal or curved. One or more of the bars may be tilted. Additionally or alternatively, the secondary information may be embedded within the height of the bars. The bar code may be a linear bar code or a stacked bar code or a two dimensional bar code.

According to another aspect of the present invention, there is provided a method comprising including security/authentication information in a code that is otherwise used for error correction. The bar code may be a linear bar code or a stacked bar code or a two dimensional bar code.

According to yet another aspect of the present invention, there is provided a method for authenticating a bar code that is accompanied by one or more alphanumeric characters, the method comprising modulating the alphanumeric characters to encode secondary authentication information. The modulation may comprise varying the alignment of one or more of the characters. The bar code may be a linear bar code or a stacked bar code or a two dimensional bar code.

According to yet another aspect of the invention, there is provided a method for enabling authentication of a bar code comprising modulating the reflectivity of one or more of the bars, thereby to embed secondary information within the code. By reflectivity, it is meant the greyscale level or value. Preferably, the reflectivity is modulated by 5% or less.

According to still another aspect of the invention, there is provided a printed bar code comprising one or more bars that has a modulated reflectivity, the modulation representing secondary information.

### BRIEF DESCRIPTION OF THE DRAWINGS

Various aspects of the invention will now be described by way of example only with reference to the accompanying drawings, of which:

FIG. 1 is an example of a linear bar code;

FIG. 2 shows an enlarged view of a linear bar code in which a trapezoidal bar shape is used to embed secondary information;

FIG. 3 shows an enlarged view of another linear bar code in which a trapezoidal bar shape is used to embed secondary information;

FIG. 4 shows an enlarged view of yet another linear bar code in which each bar is curved, thereby to embed secondary information;

FIG. 5 shows an enlarged view of a further linear bar code that includes secondary information in the height of the bars, where the height of selected bars is less than for bars that do not include secondary information;

FIG. 6 shows an enlarged view of another linear bar code that includes secondary information in the height of the bars, where the height of selected bars is more than for bars that do not include secondary information;

FIG. 7 is an example of a stacked linear bar code;

FIG. 8 is an example of a stacked linear bar code that is used in postal services;

FIGS. 9 to 12 show examples of various two-dimensional bar codes;

FIGS. 13 and 14 show examples of two dimensional bar codes in which information has been embedded using changes in the width of blocks of pixels having adjacent faces;

FIG. 15 shows examples of two-dimensional bar codes in which information has been embedded using changes to the corners of pixels;

FIG. 16 shows two bar codes in which secondary information is embedded within changes in the bar's reflectivity, and

FIG. 17 shows bars of a code in which the reflectivity is varied

### DETAILED DESCRIPTION OF THE DRAWINGS

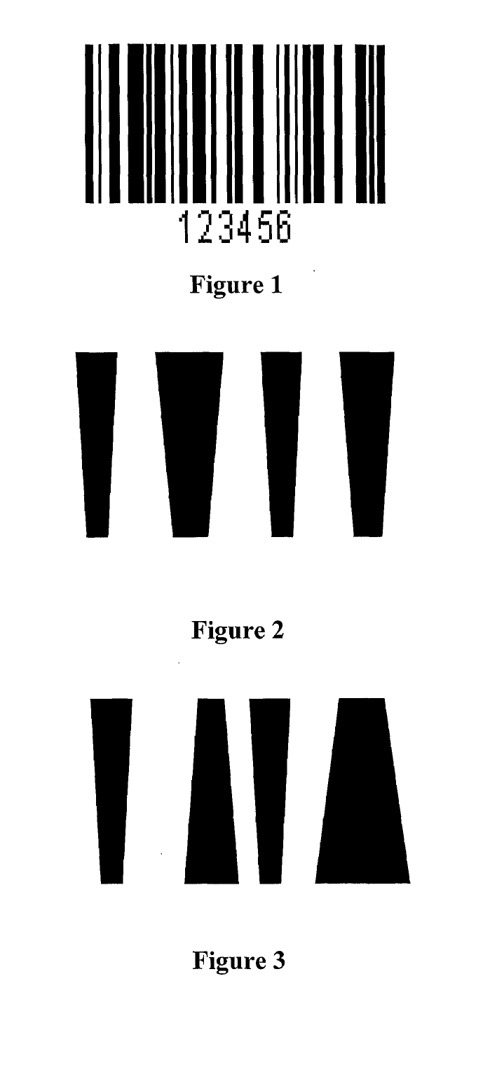

FIG. 1 shows a conventional linear bar code. This has a plurality of bars and spaces of varying width that is a multiple of a unit width X that can be decoded using a bar code scanning device, thereby to reveal the primary data. Each bar is rectangular and has a pre-determined, uniform height. Below the bars are alphanumeric characters. In accordance with one aspect of the invention, additional or second order information is embedded in the bar code of FIG. 1 by varying the overall shape of at least one of the bars, the bars being varied by different amounts or in different ways. Any peripheral distortions that are used are insufficient to affect the ability of a standard barcode reader to read the primary data, but sufficient to convey secondary information. For linear bar codes the distortion is preferably less than X/10, where X is the unit of width of the bar that would be used in the absence of the secondary information. In any case, any modifications should be such that the primary bar code information remains defined by the width of the bars, but the secondary information is embedded within the overall shape.

Various tilts and curvatures may be introduced or applied to the bar code of FIG. 1, thereby to encode secondary information. For example, a distortion function could be applied so as to mimic the effect of a barcode being placed on a curved surface. Alternatively, each bar code could be distorted to have a trapezoidal shape, as shown in FIGS. 2 and 3. Provided the distortion of each bar in the scanning direction results in lines with widths that are within +/−0.1× of the width that would be used in the absence of the secondary information, a standard bar code scanner should be able to read the data without requiring any modification. This is advantageous, because embedding the second order data would not interfere with the operation of conventional reading equipment. Of course, if the second order data had to be read, a high-resolution reader would have to be programmed to read the extra geometric information.

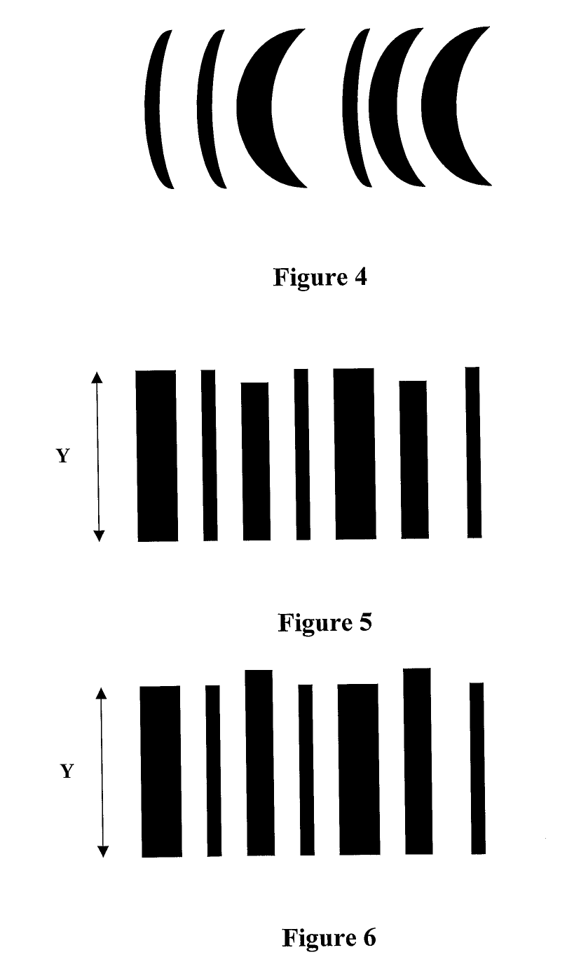

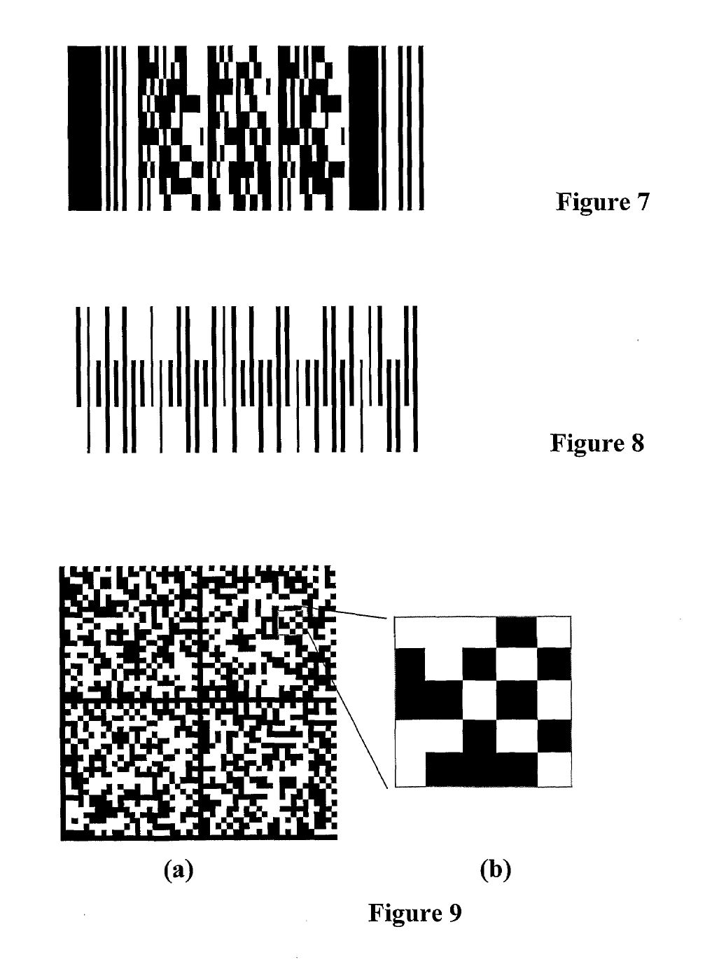

FIG. 4 shows another option for altering the periphery of the bars to include additional information. In this case, each bar is curved, with the primary bar code information being defined by the width of the bars, but the secondary information being embedded within the shape of the curves. Alternatively or additionally, the heights of the bars could be modulated, as shown in FIG. 5, in which some of the bars have a length that is shorter than the length Y of the standard bars. Equally, as shown in FIG. 6, some of the bars could be longer than the other, standard length bars. Here, the primary bar code information is defined by the width of the bars, but the secondary information is embedded within height changes. Of course, a combination of these could be used, that is some bars that are longer than conventional and some that are shorter. For either of FIG. 5 or 6, the height should preferably be varied from the standard height Y by no more than 5% of the standard height Y or X/3, i.e. about a third of the unit width of the lines.

Whilst FIGS. 2 to 6 show enlarged views of various bar codes in which distortions or variations to the bar edges can be clearly seen, it will be appreciated that in practice these variations would be sized so as not to interfere with decoding of the primary data and would not be visible to the unaided eye.

Stacked linear barcodes are a variation on the more conventional linear bar code of FIG. 1. Examples of these codes are shown in FIGS. 7 and 8, where FIG. 7 shows a PDF417 stacked linear barcode and FIG. 8 shows a stacked linear postal bar code that is used by the Royal Mail. As before, secondary information can be embedded within these codes by varying the peripheral shape of the bars. Various possibilities exist here, whilst still allowing the code to be read using conventional readers. For example, the heights of the rows could be modulated and/or the widths of the bars.

As an alternative or in addition to using the peripheral shape of the bars, alphanumeric characters associated with the bar code could be used to convey secondary information. This can be done by, for example, modulating the vertical or horizontal position of the characters or varying the font weight, size or typeface from one character to the next.

Another option involves the use of “mode characters”. The normal function of the mode characters is to indicate to a scanner a change of mode, for example, between reading letters and numeric data or between reading different densities of data. Code 128 is a popular linear barcode symbology. It has three encoding modes “Mode A”, “Mode B” and “Mode C” and provides special characters to allow the mode in the middle of the barcode to be switched (e.g. from “Mode A” to “Mode B”). The modes are intended to enable good data density (e.g. “Mode C” provides good data density for numeric data). However, mode switches could be introduced as a way of encoding addition information. For example, “Mode A” and “Mode B” both encode alphanumeric data. A 4-bit code could be introduced by inserting four switches from “Mode A” to “Mode B” or “Mode B” to “Mode A”. This would not affect the data read out by a standard barcode reader, but a modification of the barcode software could allow the mode switches to also be interpreted as additional data.

In addition to the above, the conventional error correction that is used in both linear and stacked bar codes could be modified and utilised to carry additional information. For example, deliberate error bits could be introduced into the barcode, in order to convey secondary information, e.g. a 32 bit error code could be modified to include 16 bits of deliberate errors. Under reasonable conditions, this should not affect the ability of a standard barcode reader to read the barcode, but would allow modified software to determine the deliberately introduced errors and use these to decode any secondary information.

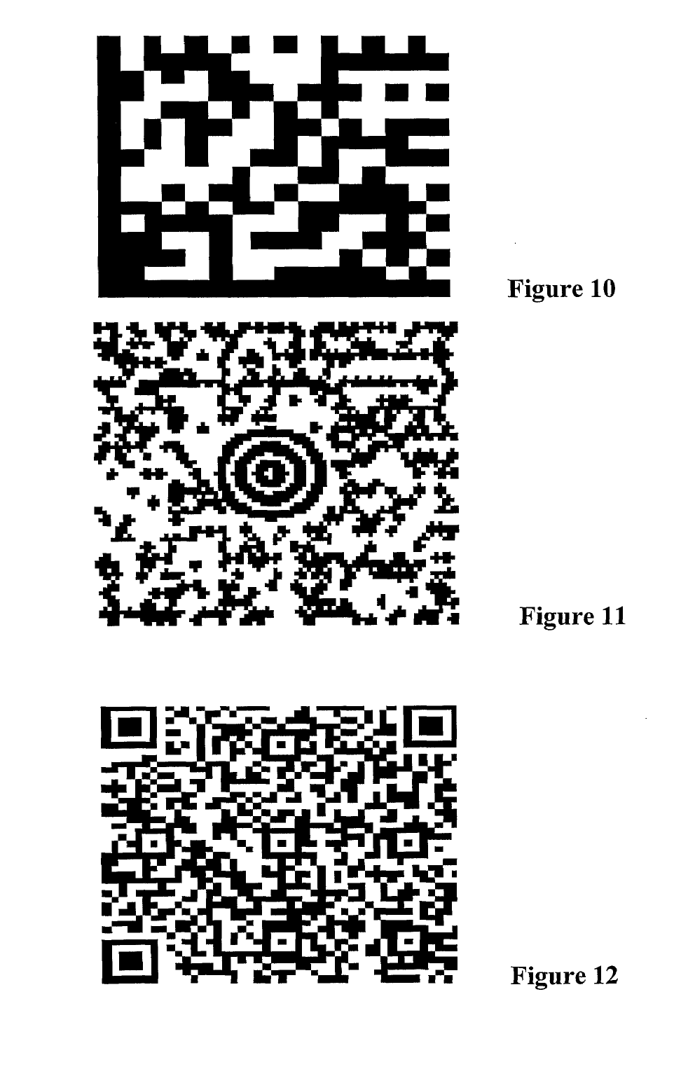

FIGS. 9 to 12 show examples of two-dimensional barcodes. These can differ widely in appearance, although they have some common features including an alignment feature, which is fixed and carries no data, and error correction features. In addition, the data-carrying elements are laid out on a regular array, for example square array for Aztec, Data Matrix and QR Code, and a hexagonal matrix for Maxicode. Options for implementing a second-order effect include modulating the alignment pixels. For example, one or two of the alignment pixels may be omitted from the printed code. This would not affect the reading of the barcode, but modified software could extract data by determining which alignment pixels were absent. Also, the peripheral shape of one or more of the pixels or cells could be distorted or varied, as discussed above for linear barcodes, and shown in FIG. 9(b).

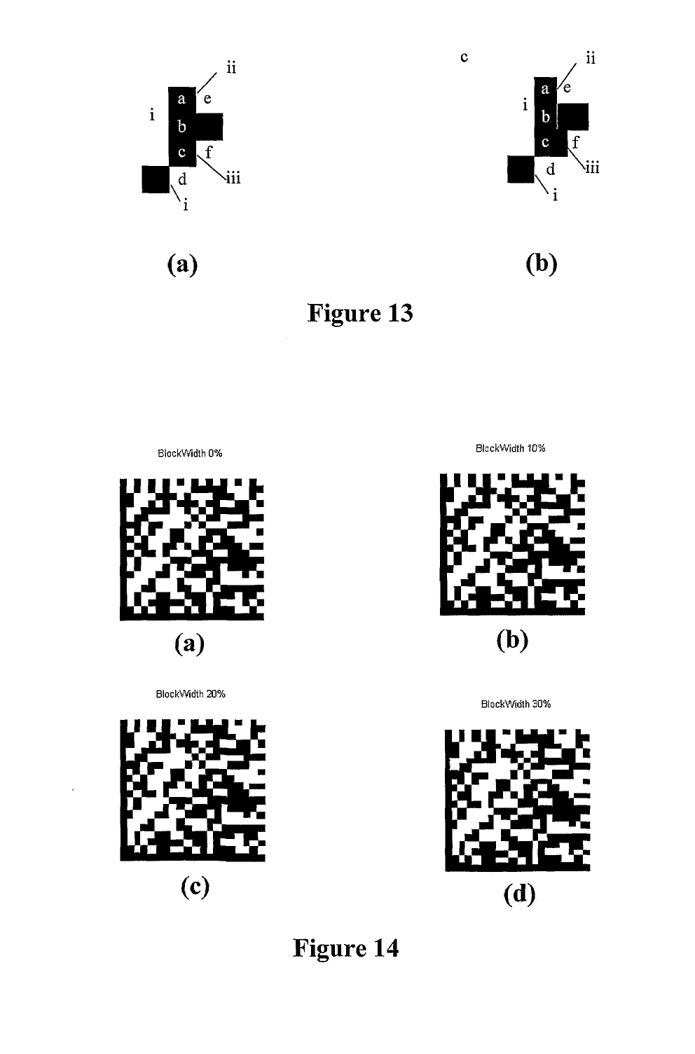

All the pixels in a conventional 2D barcode are of the same height and same width. This results in a grid of pixels, with all the pixels in each vertical column having vertically aligned edges and all the pixels in each row having horizontally aligned edges. FIGS. 13 and 14 show a further option for encoding secondary information in 2D barcodes. In this case, the periphery of one or more or groups of the pixels or cells is altered. In a preferred example, groups or blocks of like, adjacent pixels that are horizontally and/or vertically aligned are selected, for example, a row of white pixels bordered by a row of black pixels or a column of black pixels bordered by a column of white pixels, where the rows and/or columns or pixels extend partially or wholly across the 2D grid, so that sub-groups within a row or column may be aligned. The secondary data can be encoded by selectively moving the boundary between the groups of pixels, so that, for example, all of the black pixels in a row have their heights reduced by the same amount and all the adjacent white pixels have their heights correspondingly increased. Likewise, all of the black pixels in a column could have their widths reduced by the same amount and all the adjacent white pixels have their widths correspondingly increased. An advantage of varying adjacent, like pixels by the same amount is that changes to the overall layout of the bar code caused by the embedding of the secondary information are more difficult to see using the unaided eye.

To illustrate the encoding of information in groups of pixels, FIG. 13(a) shows a 2D bar code that has pixels a, b, c and d having adjacent vertical faces to their left, which form an edge i defining a transition between light and dark pixels. As shown in FIG. 13(b), in order to encode additional information, each of the left edges of pixels a, b, c and d is moved together such that edge i remains aligned. In contrast, the vertical faces, ii and iii, of pixels e and f respectively can be independently moved, as they are not adjacent. This block modulation technique can be applied to each group or block of like pixels that define a horizontal or vertical boundary with pixels of a different colour, provided that all the pixel edges that define the boundary are moved by the same amount. Moving all the edges in a block by the same amount reduces the likelihood of variations in the car code being detectable by eye.

FIG. 14 shows how block modulation can be applied to a 2D bar code. FIG. 14(a) shows the basic, unaltered bar code, whereas FIGS. 14(b), (c) and (d) show the edges varied by 10%, 20% and 30% respectively. Keeping the pixel faces aligned results in an effect that is harder to detect than encoding the secondary information using a method that results in misalignment of adjacent faces. However, the number of bits of secondary information that can be encoded in the image is approximately half that obtainable by modulating individual pixels. Encoding the data by independently varying pixel heights and widths maximises the amount of second order data that may be stored. In alternate embodiments, only the heights or widths of pixels or blocks of pixels may be varied. This method is advantageous when either the vertical or horizontal pixel faces are more clearly defined or less smudged than the other, for example, as an artefact of the printing process used.

Depending on the arrangement of pixels, the number of boundaries between groups will vary between barcodes. The number of error correction bits contained within the barcode is varied so that the total number of bits (number of message bits plus number of error correction bits) equals the number of edges.

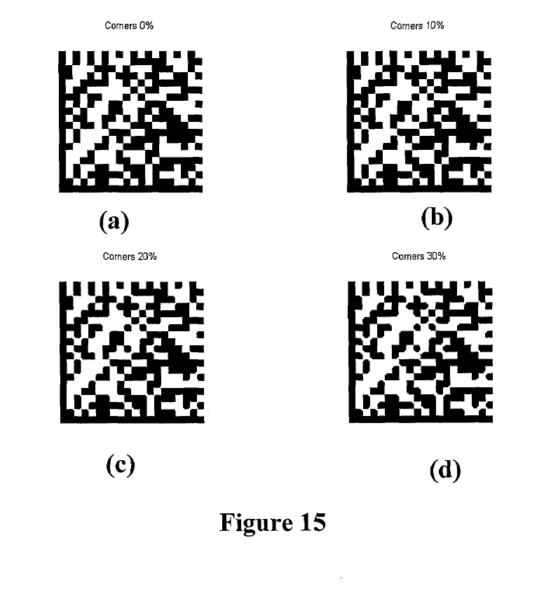

Another example of an option for altering the periphery of barcodes is modifying the shapes of the bars or pixels of the barcode, as shown in FIGS. 15(a) to (d), which show the corners varied by 0%, 10%, 20% and 30% respectively. For example, this may involve rounding off the corners of pixels or bars. For example for a 2D bar code, the corner of a black pixel that is at a junction with three white pixels could be rounded off. This rounding can be detectable to give a binary secondary data stream.

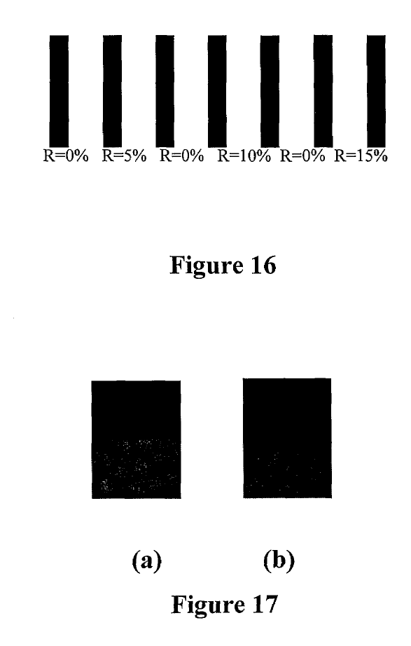

In addition or as an alternative to the methods described above, another option for including secondary information within a bar code is to vary the reflectivity of the black bars. Ideally, this should be done within the wavelength band used by standard barcode readers, so that modification of the reader hardware is not needed. In this case, reading the secondary data would only require a modification to the software of standard barcode readers. For this encoding technique, modulation of the reflectivity is preferably less than or equal to 5%. This is because below 5% the modulation is very difficult, if not impossible to detect by eye. In contrast, at modulations of above 10%, the variation in reflectivity can be visually detected. This is demonstrated in FIG. 16, which shows black bars that have a range of different reflectivities. From this, it can be seen that the 5% bar is barely distinguishable from the neighbouring, un-modulated black bars, but the 10% and 15% bars are more easily detected. Hence, in order to make the secondary data covert, ideally the reflectivity modulation should be less than 5%. In addition, the variations in reflectivity may be arranged to mimic those that occur naturally.

Various options for varying the reflectivity of the black bars are possible. For example, a different reflectivity could be used for each bar and space in a linear barcode. Equally, for a 2D bar code, a different reflectivity could be used for one or more of the pixels or cells. In either case, the reflectivity could be applied uniformly over each bar or blob, or the reflectivity within each individual bar could vary. For example for a linear bar, the reflectivity could vary up the height of the or each bar. This could be done by having a sharp transition or by varying the reflectivity gradually.

FIG. 17(a) shows an example of a bar that has two distinct portions separated by a sharp reflectivity transition, the upper portion having a lower reflectivity than the lower portion. FIG. 17(b) shows a bar in which the reflectivity changes gradually along its length. As can be seen, from FIG. 17, the eye can discriminate reflectivity variations of a few percent when there is a sharp boundary, as shown in FIG. 17(a). However, gentle gradations in shade are much harder to detect by eye, as shown in FIG. 17(b). In general, the gradual change of reflectivity of FIG. 17(b) is preferred.

To print secondary information that is encoded within variations in reflectivity, printers that can print greyscales with good precision are needed. To read this encoded information, laser scanners and 2D imagers that can detect relative greyscales to high precision are also needed. To achieve ‘A’ grading, that is the highest defined quality, with linear barcodes, various quality requirements limit the modulation of reflectivity that can be used. However, in practice all of the requirements can be met if the “white” areas have a reflectivity >85% and the “black” areas have a reflectivity <15%.

In practice, it has been found that the printer used has an impact on the density of the modulation. Lower density modulation occurred when the barcodes were printed using a colour laser printer than when using a monochrome laser printer (even though the same file was printed in each case). This means that the file used to generate the barcodes must take into account the ‘transfer function’ of the printing method to be used. Alternatively, the software used to demodulate the barcode must do this.

To successfully decode the secondary information, in practice, it is necessary to correct variations in illumination of the image, which could cause variations that would otherwise swamp the secondary data modulation. To do this, the image is broken down into a number of sub-images. For example, the grid may be broken into a 10 by 10 grid of sub-images. Once this is done, the maximum and minimum pixel values within each sub-image are calculated. The maximum value is then assumed to correspond to white at the centre of the sub-image. Similarly, the minimum value is assumed to correspond to black at the centre of the sub-image. This is provided some pre-determined criteria are satisfied, since not all sub-images will necessarily contain black. Linear interpolation is then performed to calculate the expected values for white and black across the whole image, and each pixel scaled accordingly. Once this is done, the reflectivity can be decoded/demodulated, thereby to reveal the secondary information.

Another factor in the scanning system that has to be taken into account is the performance of the imaging lens. This can be represented by its Modulation Transfer Function (MTF), which describes how well varying spatial frequencies are imaged by the optical system. If the system were used to image a grid of parallel lines and spaces, as the line and space width decreases, the image modulation, or contrast, between the black lines and white spaces will begin to decrease. This means that narrow lines appear to have a lower density than the broader lines in the bar code. The spatial frequency at which the roll-off starts is dependant on focus, f/number (size of the aperture) and aberrations in the lens system. Using a higher resolution imager and a better lens would increase the spatial frequency of the cut-off and reduce the loss of density in the narrow bar-lines. Alternatively, the captured data would have to be processed to correct this.

A skilled person will appreciate that variations of the disclosed arrangements are possible without departing from the invention. For example, irrespective of how secondary data is introduced into a barcode, various methods can be used to ensure the security of that data. For example, the secondary data may be encrypted with a secret key. Equally, the secondary data may be varied between barcode instances so that it cannot be simply copied. Another option is to encode the secondary data at close to the detection limit and use large amounts of error correction. An advantage of this is that a high quality printer would be needed to copy this, which reduces the likelihood of fraudulent copies being made.

Alternatively or additionally, the secondary data could be distributed across a batch of barcodes, so that it can only be detected by statistical analysis of a whole batch. Regarding the nature of the secondary information, this may include security information for authenticating the bar code itself and/or may merely be further information relating, for example, to the goods to which the code is applied. In this way, the data capacity of the bar code can be increased. Accordingly the above description of the specific embodiment is made by way of example only and not for the purposes of limitation. It will be clear to the skilled person that minor modifications may be made without significant changes to the operation described.

1. A method for embedding secondary information in a bar code that includes primary information, the method comprising varying the periphery of selected ones of the bars or pixels of the code and/or varying the periphery of at least some of the bars or pixels by different amounts and/or varying the peripheral shape of at least some of the bars or pixels.

2. A method as claimed in claim 1 comprising varying the periphery by applying a distortion function.

3. A method as claimed in claim 1 comprising varying the peripheral shape by rounding off at least one corner of at least one bar or pixel to encode the secondary information.

4. A method as claimed in claim 1 comprising varying the peripheral shape so that the or each bar or pixel has a trapezoidal shape or at least one curved side.

5. A method as claimed in claim 1 comprising modulating bar or pixel height and/or width to encode secondary information.

6. A method as claimed in claim 1 wherein the secondary information on the periphery of the or each bar or pixel is indiscernible by eye.

7. A method as claimed in claim 6 wherein the bar code is linear and the bar height is varied by an amount that is less than or equal to 5% of the original height, or X/3, where X is the unit of bar width.

8. A method as claimed in claim 1 wherein the bar code is a 1D linear bar code and each bar that includes secondary information has a width that varies from the unit width X of the bar without the secondary information by less than X/10.

9. A method as claimed in claim 1 wherein the bar code is 2D and at least some adjacent, like pixels that form a boundary with pixels of a different colour are grouped together as a block and the periphery of the pixels in the block varied by the same amount.

10. A method as claimed in claim 9 wherein pixels in different blocks are varied by the same or different amounts.

11. A method as claimed in claim 1 wherein at least one block extends horizontally.

12. A method as claimed in claim 1 wherein at least one block extends vertically.

13. A printed bar code comprising one or more bars in which secondary information is embedded at the periphery of selected ones, but not all, of the bars.

14. A printed bar code comprising a plurality of bars at least some of which are modulated at their peripheries by different amounts or in different ways.

15. A printed 2D bar code comprising at least some adjacent, like pixels that form a boundary with pixels of a different color and are grouped together as a block, wherein the peripheries of the pixels in the block that define the boundary are varied by the same amount to include secondary information.

16. A method for enabling authentication of a bar code comprising modulating the reflectivity of one or more of the bars, thereby to embed secondary information within the code.

17. A method as claimed in claim 16 wherein the reflectivity is modulated by 5% or less.

18. A method as claimed in claim 16 wherein the modulation is a step change in the reflectivity.

19. A method as claimed in claim 16 wherein the modulation is a gradual change in the reflectivity.

20. A printed bar code comprising one or more bars that has a modulated reflectivity, the modulation representing secondary information.

21. A method for authenticating a bar code, the method comprising including authentication information in a code that is associated with the bar code, but is otherwise used for error correction.

22. A method for authenticating a bar code that is accompanied by one or more alpha-numeric characters, the method comprising modulating the alpha-numeric characters to encode secondary authentication information.

23. A method as claimed in claim 22 wherein the modulation comprises varying the alignment of one or more of the characters.

24. A method or printed bar code as claimed in claim 22 wherein the bar code is selected from at least one of: a linear bar code, a stacked bar code and a two dimensional bar code.
